(19) United States
(12) Patent Application Publication
(10) Pub. No.: US 2012/0221454 A1
(43) Pub. Date: Aug. 30, 2012

(54) SYSTEMS AND METHODS FOR GENERATING MARKETPLACE BROKERAGE EXCHANGE OF EXCESS SUBSCRIBED RESOURCES USING DYNAMIC SUBSCRIPTION PERIODS

(76) Inventor: Christopher Edwin Morgan, Raleigh, NC (US)

(21) Appl. No.: 13/037,351

(22) Filed: Feb. 28, 2011

(51) Int. Cl. G06Q 40/00

(52) U.S. Cl. 705/37

(57) ABSTRACT

Embodiments relate to systems and methods for generating a marketplace brokerage exchange of excess subscribed resources using dynamic subscription periods. A set of aggregate usage history data can record consumption of processor, software, or other resources subscribed to by a set of users, in one cloud or across multiple clouds. An entitlement engine can analyze the usage history data to identify a subscription margin for the subscribed resources, reflecting collective under-consumption of resources by the set of users on a collective basis, over different and/or dynamically updated subscription periods. In aspects, the set of estimated resource contributions of different users can be aggregated over one or more dynamic resource contribution intervals to generated a bundled brokerage resource tender, in which the processor, operating system, and/or other resources of multiple users are combined to be offered to a cloud marketplace for one or more contribution interval. The bundled resource offer can be structured to contain at least a threshold amount of resources over a minimum or other defined contribution interval, after which resources are released back to the contributing users.

### FIELD

The invention relates generally to systems and methods for generating a marketplace brokerage exchange of excess subscribed resources using dynamic subscription periods, and more particularly, to platforms and techniques for identifying and tracking the excess resource capacities of a set of users subscribing to resources in the cloud over diverse or varying subscription periods, and aggregating those resources to present in a bundled resource offering to a set of marketplace clouds over uniform or synchronized time intervals, on a combined basis.

### BACKGROUND

The advent of cloud-based computing architectures has opened new possibilities for the rapid and scalable deployment of virtual Web stores, media outlets, social networking sites, and many other on-line sites or services. In general, a cloud-based architecture deploys a set of hosted resources such as processors, operating systems, software and other components that can be combined together to form virtual machines. A user or customer can request the instantiation of a virtual machine or set of machines from those resources from a central server or cloud management system to perform intended tasks, services, or applications. For example, a user may wish to set up and instantiate a virtual server from the cloud to create a storefront to market products or services on a temporary basis, for instance, to sell tickets to or merchandise for an upcoming sports or musical performance. The user can subscribe to the set of resources needed to build and run the set of instantiated virtual machines on a comparatively short-term basis, such as hours or days, for their intended application.

Typically, when a user utilizes a cloud, the user must track the software applications executed in the cloud and/or processes instantiated in the cloud. For example, the user must track the cloud processes to ensure that the correct cloud processes have been instantiated, that the cloud processes are functioning properly and/or efficiently, that the cloud is providing sufficient resources to the cloud processes, and so forth. Due in part to the requirements and overall usage of the cloud, the user may have many applications and/or processes instantiated in a cloud at any given instant, and the user's deployment of virtual machines, software, and other resources can change dynamically over time. In cases, the user may also utilize multiple independent host clouds to support the user's cloud deployment. That user may further instantiate and use multiple applications or other software or services inside or across multiple of those cloud boundaries, and those resources may be used or consumed by multiple or differing end-user groups in those different cloud networks.

In terms of the administrative capture of a user's resource consumption that may be spread across several independent host clouds, existing platforms today provide no mechanism by which a resource provider and/or other operator or administrator can track the resource consumption by the user across all currently utilized host clouds, in an organized or centralized fashion. That is, the user may have instantiated a certain number of instances or copies of an operating system or application in one host cloud, while at the same time running or executing another number of instances of the same operating system or application in another, independent host cloud or clouds. In instances, the set of host clouds may operate independently and with no operating agreement between them. Usage data for the user may therefore not be shared or be visible between those host clouds. In addition, the set of host clouds can also change over time during the course of a week, month, and/or other period, making coordination of subscription details including usage history difficult or impossible.

In cases where the user may subscribe to operating system, application, and/or other software or hardware resources based on subscription levels or limits, it may accordingly be difficult or impossible to keep a running tally of the user's resource consumption on an aggregate basis, across all operative host clouds. If the user, for instance, has a subscription limit of 300 instances of an executing application with a per-cloud limit of 100 instances, and reaches 100 instances in one host cloud at the same time that 90 instances of that application is operating in a second host cloud and 120 are operating in a third cloud, the application provider, individual host clouds, and/or other entities may not be able to timely or accurately determine that the user has reached their instance limit in one cloud, and exceeded their instance threshold in a second cloud. This can occur, for example, because individual host clouds may not have visibility on the resource consumption and/or subscription limits or parameters that may apply in other clouds.

Moreover, those entities and their associated billing infrastructure may not be equipped to identify not just over-consumption of resources within certain subscription or usage periods, but also under-consumption of those resources. The individual host clouds and other entities may therefore not be able to accurately apply the user's subscription limits and/or other parameters, such as supplemental billing for over-limit resource consumption, on an aggregate basis. Among other things, this may prevent any individual host cloud, or application provider or other resource provider, from identifying the potential under-consumption of one or more subscribed resources in diverse host clouds that could, in theory, be captured and aggregated to permit the user to receive a credit, offset, and/or other adjustment to their overall subscription costs, on an aggregate basis.

Further, in terms of subscription management and associated tracking of resource consumption, in known cloud management systems and related billing infrastructure, the subscription period or other time interval that is used to track the user's consumption of processor, memory, operating system, or other resources may be fixed or predetermined. That interval may be set, for example, to a one-hour, one-day, and/or other period or interval over which the user's consumption of cloud resources is accumulated. When a conventional cloud management system employs such fixed or relatively coarse-grained set of intervals, however, the resource usage that is captured may not be fully accurate or timely. When the cloud management system or associated logic takes a snapshot of operating system instances, for instance, on a once-per-hour basis, if a particular user exhibits bursty or other transient consumption patterns, such as consumption of operating system instances that exceeds subscription limits for only a few minutes at a time, the tracking infrastructure may not be able to detect or resolve those peaks. In cases, the user's subscription levels might call out for additional subscription fees, limit adjustments, and/or other factors that should be applied to large or transient excursions in resource consumption. Those factors may not be accounted for when the cloud management system or associated administrative infrastructure is incapable of detecting such consumption events within a relevant consumption period.

In further aspects, it may be desirable for users to identify periods in which they exhibit or are expected to exhibit a temporary reduction in resource consumption, thus resulting in potential excess capacity in the subscribed resources over relatively short-term periods. When that scenario takes place, the temporarily unused resources may be able to be leveraged to offer those resources to a set of marketplace clouds on a short-term basis. That is, the user having temporary excess capacity in their subscribed cloud resources may wish to offer to temporarily re-assign those resources to other users and/or cloud providers requiring additional short-term resources, on a spot marketplace or brokered basis.

In instances, a set of users, such as a collection of related users within an organization or, in cases, a set of unrelated users, may consider combining their excess resource capacities to produce a bundled resource package to offer to a set of marketplace clouds, on a combined brokered basis. The aggregation of diverse resources from multiple users can achieve, among other things, larger total capacities, redundancies, and/or other features for resources in the resource brokerage bundle contributed to the set of marketplace clouds.

Identifying and preparing a set of resources for a resource brokerage bundle to be offered or tendered to a set of marketplace clouds can, however, involve or encounter various issues that could hamper resource delivery. For one, the various users experiencing or expecting short-term excess resource capacities may not all be operating on the same subscription periods, so that while each may have resources to potentially contribute, the periods over which they can broker those resources may be of different lengths, and/or start or end at different times so that staggering those resources for delivery may be difficult in unaltered form. In addition, in cases, unequal or non-synchronized subscription periods can result where one or more users may be operating on a dynamically adjusted or updated set of subscription periods, in which management logic may track the hourly, daily, and/or other subscription intervals for those users and lengthen or shorten those intervals, depending on peaks, bursts, or other consumption trends.

It may be desirable to provide systems and methods for generating a marketplace brokerage exchange of excess subscribed resources using dynamic subscription periods, in which the available excess capacities of a variety of users can be identified and combined for delivery to a cloud marketplace system even while those excess subscription periods vary or dynamically change, and while configuring the subscription or contribution periods for those users to permit uniform or synchronized scheduling of resource brokerage activities with the set of target marketplace clouds.

### DESCRIPTION OF DRAWINGS

FIG. 1 illustrates an overall cloud system architecture in which various aspects of systems and methods for generating marketplace brokerage exchange of excess subscribed resources using dynamic subscription periods can be implemented, according to embodiments;

FIG. 2 illustrates an overall cloud system architecture in which various aspects of systems and methods for generating marketplace brokerage exchange of excess subscribed resources using dynamic subscription periods can be implemented, in further regards;

FIG. 3 illustrates a network configuration in which systems and methods for generating marketplace brokerage exchange of excess subscribed resources using dynamic subscription periods can be implemented, including the capture and reconciliation of short-term resource consumption margins across a set of multiple users, and potentially across multiple host clouds;

FIG. 4 illustrates an exemplary data structure in which the capture and aggregation of marginal resource consumption data for multiple users, and available excess capacity from those users can be encoded and stored, according to various aspects;

FIG. 5 illustrates an exemplary data structure in which data including sets of resource contributions from multiple users for one or more dynamic resource contribution intervals can be encoded and stored, according to aspects;

FIG. 6 illustrates an exemplary hardware configuration for a cloud management system and/or other hardware that can support and maintain one or more cloud-based networks, according to various embodiments;

FIG. 7 illustrates a flowchart for the analysis and processing of short-term resource consumption by a set of users in different clouds, and the reconciliation of different marginal consumption values for those users including potentially across those clouds in an aggregate or offset subscription cost, that can be used in systems and methods for generating optimized resource consumption periods for multiple users on a combined basis, according to various embodiments; and

FIG. 8 illustrates a flowchart for the processing of excess resources over differing or varying dynamic subscription periods, according to various embodiments.

### DESCRIPTION

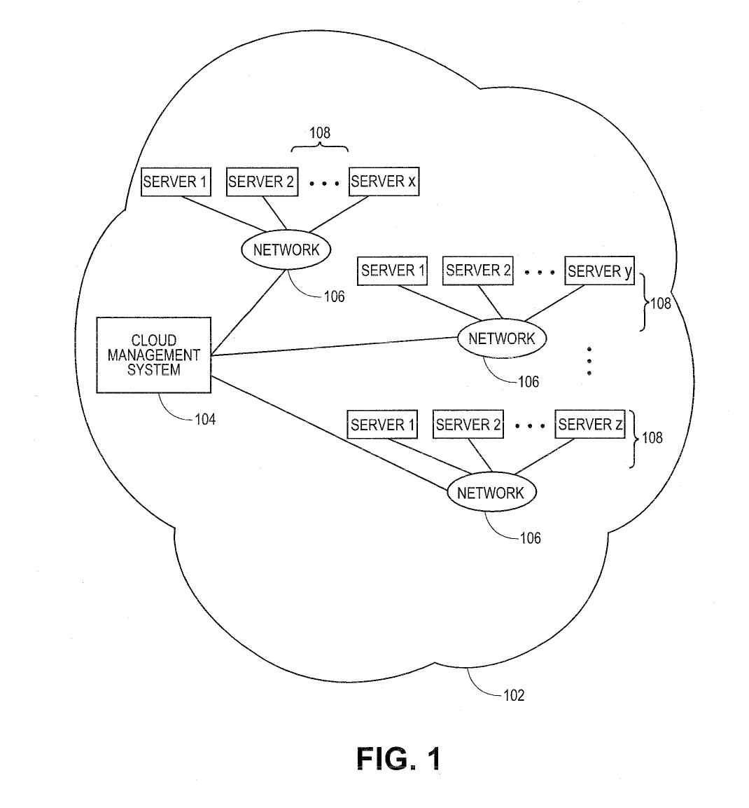

Embodiments described herein can be implemented in or supported by a cloud network architecture. As used herein, a “cloud” can comprise a collection of hardware, software, services, and/or resources that can be invoked to instantiate a virtual machine, process, or other resource for a limited or defined duration. As shown for example in FIG. 1, the collection of resources supporting a cloud 102 can at a hardware level comprise a set of resource servers 108 configured to deliver computing components needed to instantiate a virtual machine, process, service, or other resource. For example, one group of resource servers in set of resource servers 108 can host and serve an operating system, and/or components, utilities, or interfaces related to that operating system, to deliver to a virtual target, and instantiate that machine with an image of that operating system. Another group of servers in set of resource servers 108 can accept requests to host computing cycles or processor time, memory allocations, communications ports or links, and/or other resources to supply a defined level of processing power or throughput for a virtual machine. A further group of resource servers in set of resource servers 108 can host and serve applications or other software to load on an instantiation of a virtual machine, such as an email client, a browser application, a messaging application, or other applications, software, or services. Other types of resource servers can be used to support one or more clouds 102.

In embodiments, the entire set of resource servers 108 and/or other hardware or software resources used to support one or more clouds 102, along with the set of instantiated virtual machines, can be managed by a cloud management system 104. The cloud management system 104 can comprise a dedicated or centralized server and/or other software, hardware, services, and network tools that communicate via network 106, such as the Internet or other public or private network, with all servers in set of resource servers 108 to manage the cloud 102 and its operation. To instantiate a new or updated set of virtual machines, a user can transmit an instantiation request to the cloud management system 104 for the particular type of virtual machine they wish to invoke for their intended application. A user can for instance make a request to instantiate a set of virtual machines configured for email, messaging or other applications from the cloud 102. The virtual machines can be instantiated as virtual client machines, virtual appliance machines consisting of special-purpose or dedicated-task machines as understood in the art, and/or as other virtual machines or entities. The request to invoke and instantiate the desired complement of virtual machines can be received and processed by the cloud management system 104, which identifies the type of virtual machine, process, or other resource being requested in that platform's associated cloud. The cloud management system 104 can then identify the collection of hardware, software, service, and/or other resources necessary to instantiate that complement of virtual machines or other resources. In embodiments, the set of instantiated virtual machines or other resources can, for example, and as noted, comprise virtual transaction servers used to support Web storefronts, Web pages, and/or other transaction sites.

In embodiments, the user's instantiation request can specify a variety of parameters defining the operation of the set of virtual machines to be invoked. The instantiation request, for example, can specify a defined period of time for which the instantiated collection of machines, services, or processes is needed. The period of time can be, for example, an hour, a day, a month, or other interval of time. In embodiments, the user's instantiation request can specify the instantiation of a set of virtual machines or processes on a task basis, rather than for a predetermined amount or interval of time. For instance, a user could request a set of virtual provisioning servers and other resources until a target software update is completed on a population of corporate or other machines. The user's instantiation request can in further regards specify other parameters that define the configuration and operation of the set of virtual machines or other instantiated resources. For example, the request can specify a specific minimum or maximum amount of processing power or input/output (I/O) throughput that the user wishes to be available to each instance of the virtual machine or other resource. In embodiments, the requesting user can for instance specify a service level agreement (SLA) acceptable for their desired set of applications or services. Other parameters and settings can be used to instantiate and operate a set of virtual machines, software, and other resources in the host clouds. One skilled in the art will realize that the user's request can likewise include combinations of the foregoing exemplary parameters, and others. It may be noted that “user” herein can include a network-level user or subscriber to cloud-based networks, such as a corporation, government entity, educational institution, and/or other entity, including individual users and groups of users.

When the request to instantiate a set of virtual machines or other resources has been received and the necessary resources to build those machines or resources have been identified, the cloud management system 104 can communicate with one or more set of resource servers 108 to locate resources to supply the required components. Generally, the cloud management system 104 can select servers from the diverse set of resource servers 108 to assemble the various components needed to build the requested set of virtual machines, services, or other resources. It may be noted that in some embodiments, permanent storage, such as optical storage or hard disk arrays, may or may not be included or located within the set of resource servers 108 available to the cloud management system 104, since the set of instantiated virtual machines or other resources may be intended to operate on a purely transient or temporary basis. In embodiments, other hardware, software or other resources not strictly located or hosted in one or more clouds 102 can be accessed and leveraged as needed. For example, other software or services that are provided outside of one or more clouds 102 acting as hosts, and are instead hosted by third parties outside the boundaries of those clouds, can be invoked by in-cloud virtual machines or users. For further example, other non-cloud hardware and/or storage services can be utilized as an extension to the one or more clouds 102 acting as hosts or native clouds, for instance, on an on-demand, subscribed, or event-triggered basis.

With the resource requirements identified for building a network of virtual machines, the cloud management system 104 can extract and build the set of virtual machines or other resources on a dynamic, on-demand basis. For example, one set of resource servers 108, may respond to an instantiation, request for a given quantity of processor cycles with an offer to deliver that computational power immediately and guaranteed for the next hour or day. A further set of resource servers 108 can offer to immediately supply communication bandwidth, for example on a guaranteed minimum or best-efforts basis, for instance over a defined window of time. In other embodiments, the set of virtual machines or other resources can be built on a batch basis, or at a particular future time. For example, a set of resource servers 108 may respond to a request for instantiation of virtual machines at a programmed time with an offer to deliver the specified quantity of processor cycles within a specific amount of time, such as the next 12 hours. Other timing and resource configurations are possible.

After interrogating and receiving resource commitments from the set of resource servers 108, the cloud management system 104 can select a group of servers in the set of resource servers 108 that match or best match the instantiation request for each component needed to build the user's requested virtual machine, service, or other resource. The cloud management system 104 for the one or more clouds 102 acting as the destination for the virtual machines can then coordinate the integration of the identified group of servers from the set of resource servers 108, to build and launch the requested set of virtual machines or other resources. The cloud management system 104 can track the identified group of servers selected from the set of resource servers 108, or other distributed resources that are dynamically or temporarily combined, to produce and manage the requested virtual machine population, services, or other cloud-based resources.

In embodiments, the cloud management system 104 can generate a resource aggregation table or other record that identifies the various selected sets of resource servers in set of resource servers 108 that will be used to supply the components of the set of instantiated virtual machines, services, or processes. The selected sets of resource servers can be identified by unique identifiers such as, for instance, Internet protocol (IP) addresses or other addresses. In aspects, different sets of servers in set of resource servers 108 can be selected to deliver different resources to different users and/or for different applications. The cloud management system 104 can register the finalized group of servers in the set resource servers 108 contributing to or otherwise supporting the set of instantiated machines, services, or processes.

The cloud management system 104 can then set up and launch the initiation process to instantiate the virtual machines, processes, services, and/or other resources to be hosted and delivered from the one or more clouds 102. The cloud management system 104 can for instance transmit an instantiation command or instruction to the registered group of servers in the set of resource servers 108. The cloud management system 104 can receive a confirmation message back from each registered server in set of resource servers 108 indicating a status or state regarding the provisioning of their respective resources. Various registered resource servers may confirm, for example, the availability of a dedicated amount of processor cycles, amounts of electronic memory, communications bandwidth, services, and/or applications or other software prepared to be served and delivered.

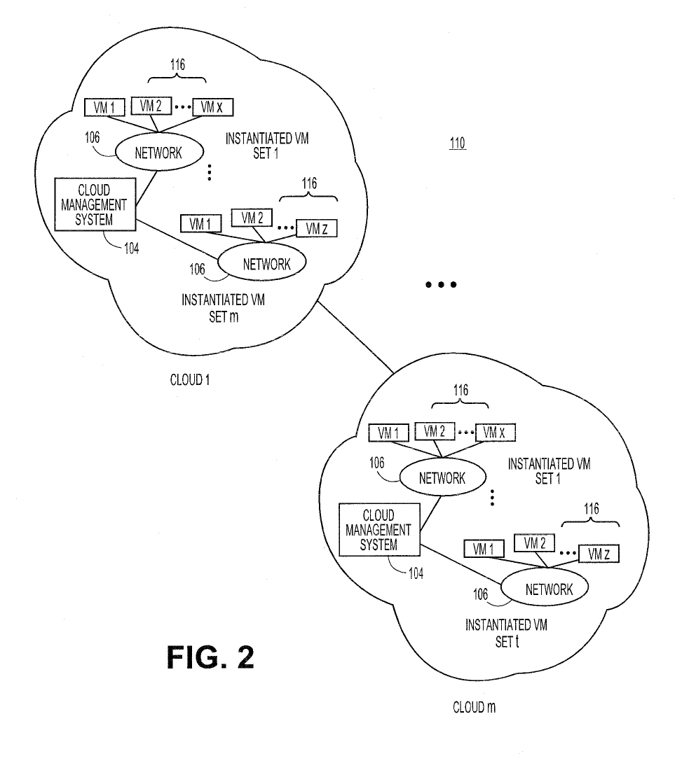

As shown for example in FIG. 2, after coordination of the sources and configuration of resources including the hardware layer, selected software, and/or other resources, the cloud management system 104 can then instantiate a set of virtual machines 116, and/or other appliances, services, processes, and/or entities, based on the resources supplied by servers within set of resource servers 108 registered to support the one or more clouds 102 in a multiple-cloud network 110. According to aspects, cloud management system 104 can access or interact with a virtualization module, platform, or service to instantiate and operate set of virtual machines 116, such as the kernel-based virtualization manager (KVM™) available from Red Hat, Inc. of Raleigh, N.C., or others. In embodiments, the cloud management system 104 can instantiate a given number, for example, 10, 500, 1000, 20,000, or other numbers or instances of virtual machines to populate one or more clouds 102 and be made available to users of that cloud or clouds. In aspects, users may access the one or more clouds 102 via the Internet, or other public or private networks. Each virtual machine can be assigned an instantiated machine ID that can be stored in the resource aggregation table, or other record or image of the instantiated virtual machine population. Additionally, the cloud management system 104 can store data related to the duration of the existence or operation of each operating virtual machine, as well as the collection of resources utilized by the overall set of instantiated virtual machines 116.

In embodiments, the cloud management system 104 can further store, track and manage each user's identity and associated set of rights or entitlements to software, hardware, and other resources. Each user that operates a virtual machine or service in the set of virtual machines in the cloud can have specific rights and resources assigned and made available to them, with associated access rights and security provisions. The cloud management system 104 can track and configure specific actions that each user can perform, such as the ability to provision a set of virtual machines with software applications or other resources, configure a set of virtual machines to desired specifications, submit jobs to the set of virtual machines or other host, manage other users of the set of instantiated virtual machines 116 or other resources, and/or other privileges, entitlements, or actions. The cloud management system 104 associated with the virtual machine(s) of each user can further generate records of the usage of instantiated virtual machines to permit tracking, billing, and auditing of the resources and services consumed by the user or set of users. In aspects of the present teachings, the tracking of usage activity for one or more user (including network level user and/or end-user) can be abstracted from any one cloud to which that user is registered, and made available from an external or independent usage tracking service capable of tracking software and other usage across an arbitrary collection of clouds, as described herein. In embodiments, the cloud management system 104 of an associated cloud can for example meter the usage and/or duration of the set of instantiated virtual machines 116, to generate subscription and/or billing records for a user that has launched those machines. In aspects, tracking records can in addition or instead be generated by an internal service operating within a given cloud. Other subscription, billing, entitlement and/or value arrangements are possible.

The cloud management system 104 can configure each virtual machine in set of instantiated virtual machines 116 to be made available to users via one or more networks 116, such as the Internet or other public or private networks. Those users can for instance access set of instantiated virtual machines via a browser interface, via an application server such as a Java™ server, via an application programming interface (API), and/or other interface or mechanism. Each instantiated virtual machine in set of instantiated virtual machines 116 can likewise communicate with its associated cloud management system 104 and the registered servers in set of resource servers 108 via a standard Web application programming interface (API), or via other calls, protocols, and/or interfaces. The set of instantiated virtual machines 116 can likewise communicate with each other, as well as other sites, servers, locations, and resources available via the Internet or other public or private networks, whether within a given cloud in one or more clouds 102, or between those or other clouds.

It may be noted that while a browser interface or other front-end can be used to view and operate the set of instantiated virtual machines 116 from a client or terminal, the processing, memory, communications, storage, and other hardware as well as software resources required to be combined to build the virtual machines or other resources are all hosted remotely in the one or more clouds 102. In embodiments, the set of virtual machines 116 or other services, machines, or resources may not depend in any degree on or require the user's own on-premise hardware or other resources. In embodiments, a user can therefore request and instantiate a set of virtual machines or other resources on a purely off-premise basis, for instance to build and launch a virtual storefront, messaging site, and/or any other application. Likewise, one or more clouds 102 can also be formed in whole or part from resources hosted or maintained by the users of those clouds, themselves.

Because the cloud management system 104 in one regard specifies, builds, operates and manages the set of instantiated virtual machines 116 on a logical or virtual level, the user can request and receive different sets of virtual machines and other resources on a real-time or near real-time basis, without a need to specify, install, or configure any particular hardware. The user's set of instantiated virtual machines 116, processes, services, and/or other resources can in one regard therefore be scaled up or down immediately or virtually immediately on an on-demand basis, if desired. In embodiments, the set of resource servers 108 that are accessed by the cloud management system 104 to support the set of instantiated virtual machines 116 or processes can change or be substituted, over time. The type and operating characteristics of the set of instantiated virtual machines 116 can nevertheless remain constant or virtually constant, since instances are assembled from a collection of abstracted resources that can be selected and maintained from diverse sources based on uniform specifications. Conversely, the users of the set of instantiated virtual machines 116 can also change or update the resource or operational specifications of those machines at any time. The cloud management system 104 and/or other logic can then adapt the allocated resources for that population of virtual machines or other entities, on a dynamic basis.

In terms of network management of the set of instantiate virtual machines 116 that have been successfully configured and instantiated, the one or more cloud management systems 104 associated with those machines can perform various network management tasks including security, maintenance, and metering for billing or subscription purposes. The cloud management system 104 of one or more clouds 102 can, for example, install, initiate, suspend, or terminate instances of applications or appliances on individual machines. The cloud management system 104 can similarly monitor one or more operating virtual machines to detect any virus or other rogue process on individual machines, and for instance terminate an application identified as infected, or a virtual machine detected to have entered a fault state. The cloud management system 104 can likewise manage the set of instantiated virtual machines 116 or other resources on a network-wide or other collective basis, for instance, to push the delivery a software upgrade to all active virtual machines or subsets of machines. Other network management processes can be carried out by cloud management system 104 and/or other associated logic.

In embodiments, more than one set of virtual machines can be instantiated in a given cloud at the same time, at overlapping times, and/or at successive times or intervals. The cloud management system 104 can, in such implementations, build, launch and manage multiple sets of virtual machines as part of the set of instantiated virtual machines 116 based on the same or different underlying set of resource servers 108, with populations of different virtual machines such as may be requested by the same or different users. The cloud management system 104 can institute and enforce security protocols in one or more clouds 102 hosting one or more sets of virtual machines. Each of the individual sets or subsets of virtual machines in the set of instantiated virtual machines 116 can be hosted in a respective partition or sub-cloud of the resources of the main cloud 102. The cloud management system 104 of one or more clouds 102 can for example deploy services specific to isolated or defined sub-clouds, or isolate individual workloads/processes within the cloud to a specific sub-cloud or other sub-domain or partition of the one or more clouds 102 acting as host. The subdivision of one or more clouds 102 into distinct transient sub-clouds, sub-components, or other subsets which have assured security and isolation features can assist in establishing a multiple user or multi-tenant cloud arrangement. In a multiple-user scenario, each of the multiple users can use the cloud platform as a common utility while retaining the assurance that their information is secure from other users of the same one or more clouds 102. In further embodiments, sub-clouds can nevertheless be configured to share resources, if desired.

In embodiments, and as also shown in FIG. 2, the set of instantiated virtual machines 116 generated in a first cloud in one or more clouds 102 can also interact with a set of instantiated virtual machines, services, and/or processes generated in a second, third or further cloud in one or more clouds 102, comprising a multiple-cloud network 110. The cloud management system 104 of a first cloud of one or more clouds 102 can interface with the cloud management system 104 of a second, third, or further cloud of one or more clouds 102 to coordinate those domains and operate the clouds and/or virtual machines, services, and/or processes on a combined basis. The cloud management system 104 of a given cloud on one or more clouds 102 can in aspects track and manage individual virtual machines or other resources instantiated in that cloud, as well as the set of instantiated virtual machines or other resources in other clouds.

In the foregoing and other embodiments, the user making an instantiation request or otherwise accessing or utilizing the cloud network can be a person, customer, subscriber, administrator, corporation, organization, government, and/or other entity. In embodiments, the user can be or include another virtual machine, application, service and/or process. In further embodiments, multiple users or entities can share the use of a set of virtual machines or other resources.

Aspects of the present teachings relate to platforms and techniques in which a central or distributed entitlement or subscription engine can communicate with each host cloud in a set of host clouds, track marginal consumption rates or values in those clouds, and aggregate the excess resource capacities of the set of users over a set of diverse, different, inconsistent, and/or dynamically varying time periods, and bundle those aggregate resources to deliver to a cloud marketplace system for potential short-term assignment to one or more marketplace clouds.

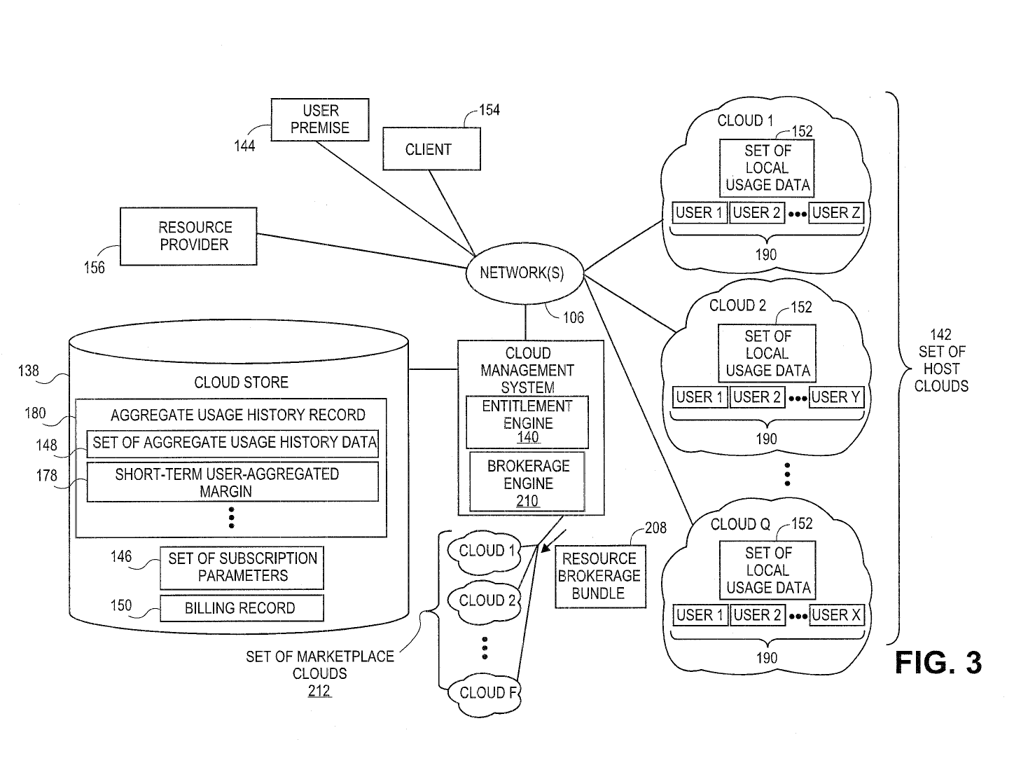

FIG. 3 shows an illustrative network configuration in which systems and methods for generating marketplace brokerage exchange of excess subscribed resources using dynamic subscription periods can be implemented, according to various embodiments. In embodiments as shown, one or more users can operate a user premise 144, such as a local area network with a set of servers and client machines, and/or other machines or resources. In aspects, a set of users 190 can in addition or instead operate one or more sets of virtual machines, appliances, and/or other virtual entities (not shown) in a set of host clouds 142. In aspects, the set of users 190 can be or include a collection of sub-groups of users who are each affiliated with or a part of the same entity, such as a corporation, government entity, and/or other organization. For example, a corporation can deploy multiple teams of engineers or developers on the same or different projects, with each team having the same or different software entitlements, user security, and/or other network features. In aspects, the corporation and/or other collective entity can establish overall subscription parameters to which its users are entitled on a collective basis. In cases, the individual teams or users may not be aware or have a mechanism by which to track overall resource consumption on a collective basis, for instance to maintain service or resource level limits. For instance, a corporation or other entity having one engineering team located on the East Coast of the U.S. with one local area or private network and administrator, a second engineering team located on the West Coast of the U.S. with a separately installed network and separate administrators and tools, a third team consisting of management personnel in Europe having separate networks, user groups or sub-groups, and a fourth team or group in South America assigned to research and development with its own network and management resources, would possibly not be able to collect and view consumption data for all users and/or groups or sub-groups of users, on an aggregate basis, using conventional cloud metering platforms. In aspects, some or all of the set of users 190 can also be unrelated or unaffiliated.

According to aspects, systems and methods according to the present teachings can permit the aggregation of consumption periods, consumption limits, subscription terms, and/or other subscription or network management details on a collective basis for or other networks hosting a potentially large-scale set of users 190, which users could be spread out over a possibly widespread set of geographic areas. In aspects, the set of host clouds 142 hosting the set of users 190 can include a set of diverse and/or otherwise unrelated cloud-based networks to which the set of users 190 can subscribe for various resources under various subscription terms, limits, criteria, service level agreements, and/or other conditions, which can be recorded or reflected in a set of subscription parameters 146. The set of subscription parameters 146 can for instance be stored in the cloud store 138 hosted or accessed by a cloud management system 104, and/or in other storage resources or locations.

In embodiments as shown, an administrator and/or other user can operate a client 154 or other interface or terminal, for instance a client located in or communicating with the user premise 144 to access the set of subscription parameters 146 and other information related to the consumption of resources in the set of host clouds 142 by the set of users 190. In aspects, the consumption of resources in the set of host clouds 142 and generation of related billing events and other subscription-related activities can be tracked and managed by an entitlement engine 140, which can be hosted in the cloud management system 104 and/or in other locations, resources, or services. According to aspects, the entitlement engine 140 can communicate with a one or more resource providers 156, such as the vendors of software such as operating systems, applications, utilities, and/or other programs, services, and/or related resources. The one or more resource providers 156 can maintain part or all of the terms, conditions, limits, criteria, stipulations, and/or other parameters of the subscription of the set of users 190 to one or more resources hosted or provisioned in the set of host clouds 142, and for instance reflected in the set of subscription parameters 146.

In embodiments, the relationship between the user premise 144 or other bare-metal or virtual machines and the set of host clouds 142 can be configured to operate on a rollover or failover basis, for instance, to provide instances of virtual machines when the installed hardware and associated resources of the user premise 144 is insufficient to support immediate processing, throughput, and/or other demands. In exemplary situations, the set of users 190 can for instance maintain or have an entitlement to 1000 instances or other limits or thresholds of an operating system operating or executing at the same time, when aggregated over all users in the set of users 190 and/or the set of host clouds 142. When the executing workload, potentially including user premise 144, demands more instances than that resource limit, the cloud management system 104 and/or other logic or services can be configured to instantiate additional virtual machines in one or more of the set of host clouds 142 to satisfy those short-term demands for the set of users 190 on a collective basis.

In that scenario, and/or in other scenarios where the set of users 190 operate an other than overflow or backup basis, each host cloud in the set of host clouds 142 can capture and store a set of local usage data 152. The set of local usage data 152 can record the consumption or use of resources in a local host cloud in the set of host clouds 142, such as the number of instances of software including operating systems and applications, processor resources, memory resources, communications resources, storage resources, and/or other elements or resources. The set of local usage data 152 can include usage data for one, some, and/or all of the set of users 190 operating virtual machines or otherwise consuming resources in each particular host cloud. The entitlement engine 140 can periodically receive the set of local usage data 152 and/or updates to that information from one or more host clouds in the set of host clouds 142. The receipt of the set of local usage data 152 or any portion of the set of local usage data 152 can be performed in aspects on a pull or demand basis, where the entitlement engine 140 and/or other logic can issue commands or instructions to one or more host clouds in the set of host clouds 142, and receive that data back from the interrogated cloud or clouds. In aspects, the set of local usage data 152 can be transmitted to the entitlement engine 140 on a push basis, for instance, on a scheduled, predetermined, event-triggered, and/or other basis initiated by one or more of the host clouds in set of host clouds 142, themselves. Other channels, schedules, and techniques for the collection of the set of local usage data 152 from any one or more of the set of host clouds 142 can be used.

After receipt of the set of local usage data 152, any portion or component of the set of local usage data 152, and/or updates to the same, the entitlement engine 140 can collect and aggregate the set of local usage data 152 from the various host clouds and organize that data in a set of aggregate usage history data 148. The set of aggregate usage history data 148 can reflect recent and/or accumulated usage consumption by the set of users 190 user in all of the set of host clouds 142, over comparatively short-term periods or intervals such as minutes, one or more hours, one day, a number of days, a week, a month or months, and/or other intervals or periods. In aspects, the entitlement engine 140 can collect the set of local usage data 152 regardless of whether each of those clouds is configured to communicate with each other or not. In aspects, the set of aggregate usage history data 148 can present to the entitlement engine 140 and/or other logic the combined resource consumption by the set of users 190 across the user premise 144 and/or all operating virtual machines or entities, on an hour-by-hour, day-by-day, and/or other relatively short-term basis.

According to aspects, the entitlement engine 140 can thereby identify comparatively short-term resource consumption by the virtual machines or other entities, sites or nodes operated by the set of users 190, and capture and track that consumption compared to the short-term limits, levels, or caps that may be contained in the set of subscription parameters 146 for that user. The entitlement engine 140 can therefore generate or determine a short-term consumption margin for each resource which the set of users 190 consume and/or subscribe to in each cloud in the set of host clouds 142, indicating whether over the course of an hour or other period the consumption rates or values are over the subscription limit for a given resource, under the subscription limit, or at or nearly at the subscription limit for that resource.

Both the over and under-consumption margins for each resource can be captured and calculated, from which the entitlement engine 140 can generate a set of short-term user-aggregated margins 178 representing the collective short-term consumption of that resource across the diverse host clouds in set of host clouds 142, resulting in an offset or aggregate consumption value. Deviations from short-term consumption caps, limits, service level agreements (SLAs), and/or other criteria can therefore be combined, averaged, aggregated, and/or otherwise “smoothed out” to more accurately and/or timely reflect the consumption patterns of the set of users 190, as a whole on an aggregate basis. In aspects, the resource provider 156, the cloud operators or providers of the set of host clouds 142, and/or other entities can thereby charge, bill, or otherwise adjust the subscription costs or other factors encoded in the billing record 150 sent to the set of users 190, for instance via an administrator or other users, so that their subscription obligations more closely track the actual consumption behavior demonstrated by the set of users 190. In aspects, the set of short-term user-aggregated margins 178 can for instance be used to establish short-term marginal subscription costs based on short-term deviations from any subscription consumption limits, which costs can then be combined over different time periods to further average or aggregate the deviations in resource consumption. In aspects, the detection of bursts and relaxations in resource consumption over relatively short-term periods can thereby allow both positive and negative offsets or margins in subscription costs, creating a more accurate assignment of subscription rates.

In implementations as shown, after detecting the set of short-term user-aggregated margins 178 for each resource of interest, the entitlement engine 140 can generate a billing record 150 reflecting that event, for purposes of notification to the user and collection of billing amounts or other responses. In aspects, the entitlement engine 140 can transmit or forward the billing record 150 to the resource provider 156, such as a software vendor, to produce and transmit to the user under agreed billing arrangements. In aspects, the entitlement engine 140 can transmit or forward the billing record 150 to one or more host clouds in set of host clouds 142, including those in which an over-limit resource usage or other event took place, to potentially transmit to the set of users 190 and/or other recipient for similar purposes. In aspects, the resource provider 156 and one or more cloud operators or cloud providers of the set of host clouds 142 can maintain agreements or arrangements for the capture and forwarding of the billing record 150, and the collection of any billing amounts or credits paid by the user. in aspects, the resource provider 156 and the host cloud providers or operators can establish arrangements to share or distribute any overage payments or other payments or credits received from users between themselves. According to aspects, the monitoring and billing capture of short or long-term over-limit resource consumption can therefore be conducted, on a marginal offset or other basis, even in instances where each host cloud in set of host clouds 142 is not aware of subscription limits contained in the set of subscription parameters 146, and/or the local usage data 152 of one or more of the set of host clouds 142 is not visible to other host clouds and/or all groups or sub-groups of users within the set of users 190, and/or to other participants in the cloud-based network.

In implementations, one or more users in the set of users 190, and/or other users or entities, may wish to identify and “harvest” the excess resource capacities reflected in the short-term consumption margin 166 when a user is consuming one or more resources at a rate or amount that is less than their subscription level or limit. The user, users and/or other entity (such as a cloud provider) may wish to locate such underutilized resources to offer, tender, and/or deliver or provide packages of those resources to one or more clouds on a comparatively short-term or temporary interval, on a marketplace or brokered basis. In aspects, the entitlement engine 140 and/or other logic or service can interact with a brokerage engine 210 to communicate with a set of marketplace clouds 212, to query, interrogate, offer, and/or exchange a resource brokerage bundle 208 identifying excess resources available to be brokered and provided to the set of marketplace clouds 212 for the use and support of those clouds on a defined, temporary, and/or other relatively short-term basis. In such cases and as also shown in FIG. 3, the entitlement engine 140, the brokerage engine 210, and/or other logic or service can detect those virtual machines, operating system instances, processor bandwidth, memory, services, clouds, and/or other entities or resources that are being underutilized, collect or aggregate those resources into the resource brokerage bundle 208, and transmit or communicate the resource brokerage bundle 208 in a command or message to the set of marketplace clouds 212, for instance, to one or more cloud management system(s) 104 associated with those marketplace clouds. The resource brokerage bundle 208 can indicate, merely for instance, that the collective set of users 190 can contribute a bundle or resources containing 100 operating system instances, processor throughput of 2000 of millions of instructions per second (MIPs) or other measure, a memory allocation of 2 gigabytes per virtual machine, an input/output (I/O) bandwidth of 1.5 gigabytes per second on one or more define communications ports, and/or other resources, assets, or services for a period of 2 hours of time from 10:00 p.m. to 12:00 midnight on a specified date. One or more clouds in the set of marketplace clouds 212 can respond to the resource brokerage bundle 208 by providing an acceptance, rejection, and/or other inquiry in a brokerage response message 214 and/or other message or data to the brokerage engine 210 and/or other logic or service. For instance, a single cloud in the set of marketplace clouds 212 can provide an acceptance message to procure or subscribe to all the resources specified in the resource brokerage bundle 208 and a rate of $100 per hour, and/or other rate.

In aspects, any subscription cost, fee, and/or other value or remuneration can be determined and/or specified in the resource brokerage bundle 208, for instance after being generated by the brokerage engine 210. in aspects, any subscription cost, fee, and/or other value or remuneration can be determined and/or specified by the cloud or cloud network in the set of marketplace clouds 212 itself. In aspects, the brokerage engine 210 and/or other logic or service can specify or indicate a subscription fee, cost, and/or other value or remuneration to be paid or exchanged in order to procure the resources specified in the resource brokerage bundle 208. In cases, that fee, cost, and/or value can be provided by user input by one or more users in the set of users 190.

In aspects, the brokerage engine 210 and/or other logic or service can manage a negotiation or exchange between the set of users 190 and/or other users or entities contributing resources to the resource brokerage bundle 208 and the set of marketplace clouds 212, for instance to determine the exact cost or value to be provided in exchange for the resources to be contributed to the set of marketplace clouds 212 and/or other resource consumers. In aspects, the exchange can determine the exact level or resources, short-term subscription or consumption period or periods, and/or other details or configuration settings for the resources to be contributed from the set of short-term user-aggregated excess capacity 202. In cases, for instance, the user in the set of users 190 contributing one or more resources to the set of marketplace clouds 212 can request or stipulate a per-unit subscription fee or value that is equal to their own or underlying subscription rate, for the resources reflected in the In further aspects, the value requested, offered, and/or calculated for the temporary contribution of the resources identified in the resource brokerage bundle 208 can be made to be changing, dynamic, and/or otherwise variable. For instance, a subscription or other fee to be paid for the use of the resources reflected in the resource brokerage bundle 208 can be made to be a function of the length of the one or more dynamic contribution intervals 204. In cases, the subscription or other fee or value can be set to be higher when the one or more dynamic contribution intervals 204 is longer. In cases, the subscription or other fee or value can be set to be higher when the level or amount of resource contribution to the short-term user-aggregated excess capacity 202 by that user is higher. In aspects, the subscription or other fee or value can be set of be a function of a combination of resources, with some resources and/or resource combinations entailing a higher subscription fee or other cost than others. Other arrangements for determining the value to be exchanged for the resources reflected in the resource brokerage bundle 208 can be used.

In aspects, the collection or bundling of unused or excess resource capacities can be performed across those users in the set of users 190 and/or associated resources having or using the same metering or subscription periods in their respective one or more short-term consumption periods 160, and/or having or using metering subscription periods that are multiples of each other. For instance, the excess resources of one user having or using a short-term consumption period of one hour can be combined with the available excess resources of a second user having or using a short-term consumption period of one half-hour, with the excess resources of the second user being combined over two (half-hour) periods with one (one-hour) period of the first user. In aspects, the collection or bundling of unused or excess resource capacities can be performed across those users in the set of users 190 and/or associated resources having or using different metering or subscription periods in their respective one or more short-term consumption periods 160, as described herein.

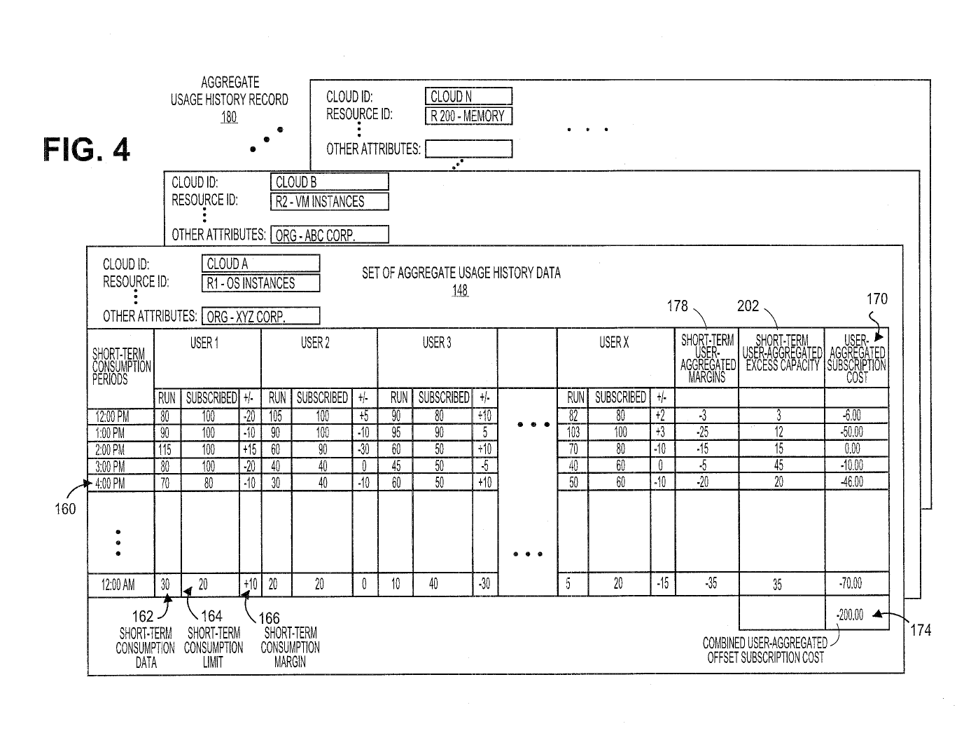

In terms of data capture of the usage, subscription, billing and related information used to detect and record marginal resource consumption, excess resource capacity flows, and/or other events, FIG. 4 illustrates an aggregate usage history record 180 that can be used to store the set of aggregate usage history data 148 that can store and encode various data, attributes, criteria, and/or other information used to track and manage the differential or marginal resource consumption in the set of host clouds 142 and/or other host sites by the set of users 190. In aspects, the aggregate usage history record 180 can be encoded as a relational or other database, table, tree, file, object, and/or other data store or data structure. In aspects as shown, the set of aggregate usage history data 148 encoded and stored in the aggregate usage history record 180 can include tables, entries, values, attributes, and/or other information including set of short-term consumption data 162 reflecting the usage of one or more resources in the set of host clouds 142 by each user in the set of users 190 over one or more short-term consumption periods 160. In aspects, the one or more short-term consumption periods 160 can be or include a variety of periods or intervals, such as one-hour intervals (as shown), but can also be or include other periods or intervals, such as 1, 5, 10, 15, and/or 30 minutes, 2 hours, 8 hours, 12 hours, one day or 24 hours, 3 days, one week, and/or other time intervals or periods. In aspects, the one or more short-term consumption periods 160 can reflect a period or interval (or periods or intervals) that is/are shorter than the period called for in the set of subscription parameters 146 as the basic or defined interval in terms of resource consumption limits or levels, service level agreements (SLAs), and/or other subscription criteria or settings. In aspects, the short-term subscription period 160 can be defined to be equal to the subscription period(s) or interval(s) defined by the set of subscription parameters 146. In aspects, the value, length, or short-term nature of the one or more short-term consumption periods 160 can be configured as dynamic, flexible, or configurable units, rather than defined as a strict number of minutes, hours, days, and/or weeks or other units. In aspects, the short-term subscription period 160 can be set or configured by a user, such as the cloud provider(s) or cloud operator(s) of the set of host clouds 142, by the one or more resource providers 156, by the set of users 190 whose set of aggregate usage history data 148 is being track and administered, and/or by other users or entities. In aspects, a record can be kept in the aggregate usage history record 180 recording, for each cloud in the set of host clouds 142 in which the set of users 190 subscribes and/or uses or consumes resources, the short-term consumption data 162 indicating an amount, rate, or other metric of resource consumption over each of the one or more short-term consumption periods 160.

In aspects as shown, the aggregate usage history record 180 can likewise include, for each cloud in the set of host clouds 142 and each resource consumed or used in that cloud, the short-term consumption limit 164 for that user based on the set of subscription parameters 146 and/or other information for each user in the set of users 190. In aspects, the entitlement engine 140 and/or other logic can generate and store a short-term subscription margin 166 reflecting the deviation in terms of under-consumption or over-consumption of each resource for which each user in the set of users 190 has a short-term subscription limit 164. The short-term subscription margin 166 can thereby reflect, on a comparatively short-term basis, such as every 15 or 30 minutes, hour, 8 hour, one-day or other period, the marginal amount by which the consumption of a subscribed resource by the set of users 190 is fluctuating and possibly deviating from the short-term consumption limit 166. In aspects, the short-term subscription margin 166 can reflect a negative value, indicating that a lesser amount of one or more resource is being consumed or has been consumed compared to limits or levels in the set of subscription parameters 146. In aspects, the short-term subscription margin 166 can reflect a positive value, indicating that a greater amount of one or more resource is being consumed or has been consumed compared to limits or levels in the set of subscription parameters 146.

In aspects, the entitlement engine 140 and/or other logic can similarly collect and sum or aggregate the short-term subscription margin 166 over each host cloud in the set of host clouds 142 in which the set of users 190 is using or consuming the subject resource to generate a set of short-term user-aggregated margins 178, representing the comparatively short-term or immediate net consumption of the resource over the set of users 190. In aspects, the set of short-term user-aggregated margins 178 can also be aggregated over two or more clouds of the set of host clouds 142. The set of short-term user-aggregated margins 178 can be calculated and stored for each hour and/or other period represented by the one or more short-term consumption periods 160, for instance over the course of one hour, day, one week, one month, and/or other period or interval. In aspects as shown, the entitlement engine 140 and/or other logic or service can further calculate and store an aggregate consumption total 172 over a defined period, such as a one-day or other period, summing or aggregating the set of short-term user-aggregated margins 178 for a resource for one user over that period. In aspects, the aggregate consumption total 172 can thereby encode the combined, net, averaged, and/or otherwise aggregated effect of the various under and over-limit consumption events by the set of users 190 in the set of host clouds 142 over 12 hours, 24 hours, and/or other predetermined interval. The entitlement engine 140 and/or other logic can, in addition, also calculate and store a set of offset subscription costs 170 reflecting the costs, surcharges, credits, and/or other adjustments for each hour and/or other period in the one or more short-term consumption periods 160 for a particular resource across the set of users 190. A resource provider, cloud operator, and/or other entity may be entitled, for instance, to an overage subscription fee or charge at a rate of $0.50 per instance for operating system (OS) instances over the short-tern consumption limit 164 based on that usage, and/or other adjustments or factors. In aspects, the set of offset subscription costs 170 can be computed at a fixed rate, and/or at a dynamically adjusted rate, for instance based on time of usage, total resource consumption, and/or other parameters. The entitlement engine 140 and/or other service or logic can also generate an aggregate offset subscription cost 174 which combines or sums the set of offset subscription costs 170 for each of the one or more short-term consumption periods 160 for a predetermined period, such as one day, one week, one month, and/or other period or interval, across the set of users 190. The aggregate offset subscription cost 174, and other consumption variables and cost factors, can in aspects thereby more accurately correspond to the overall rate or absolute amount of resource consumption in the set of host clouds 142 by the set of users 190. In embodiments, the entitlement engine 140 and/or other logic can in addition combine, sum, and/or otherwise aggregate or net the aggregate offset subscription cost 174 for multiple individual resources whose consumption data in turn has been aggregated across multiple host clouds in the corresponding aggregate offset subscription cost 174, to generate a total offset subscription cost 182. In aspects, the total offset subscription cost 182 can encapsulate the net marginal resource usage by the set of users 190 against all short-term consumption limits 164 with associated costs or credits across all host clouds in the set of host clouds 142, all subscribed resources, and/or all daily or other operative time periods constructed from the one or more short-term consumption periods 160.

In aspects and as likewise shown in FIG. 4, the entitlement engine 140 and/or other logic or service can also generate and store a record or value for a short-term user-aggregated excess capacity 202, based on the set of short-term user-aggregated margins and/or other data. In aspects, the short-term user-aggregated excess capacity 202 can reflect the sum or aggregation of the available or excess resources represented in the set of short-term consumption margins, for instance by a negative value and/or other value. In aspects, the short-term user-aggregated excess capacity 202 can be aggregated over all users in the set of users 190 showing or displaying excess resource capacity in their respective short-term subscription margin 166. In aspects, the short-term user-aggregated excess capacity 202 can in addition or instead be aggregated over multiple clouds or all clouds in the set of host clouds 142, and/or from other sources, such as non-cloud virtual machine or networks. In aspects, the short-term user-aggregated excess capacity 202 can be aggregated over sets of resources for which the one or more short-term subscription periods 160 are the same, represent multiples of each other, start and/or stop at the same time, and/or otherwise represent aligned, synchronized, or consistent periods or intervals. In aspects, the short-term user-aggregated excess capacity 202 can be aggregated over sets of resources for which the one or more short-term subscription periods 166 are different, are not multiples of each other, do not stop and/or stop at the same time, and/or otherwise are not synchronized or aligned. In aspects, in cases where the resources reflected in the short-term user-aggregated excess capacity 202 are not based on consistent or synchronized periods in the one or more short-term subscription periods 160, the entitlement engine 140, brokerage engine 210, and/or other logic can perform aggregation activities to combine, align, stagger, and/or otherwise generate consistent resource delivery over one or more uniform or rationalized resource contribution periods.

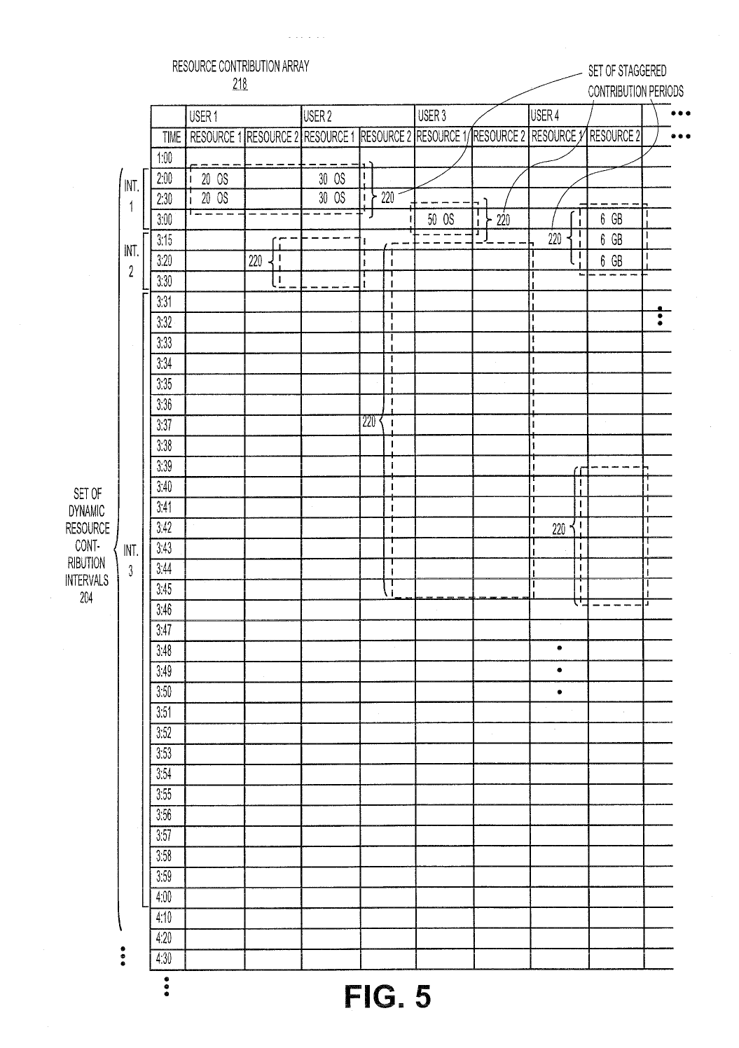

According to those and related aspects of the present teachings, and as for example further shown in FIG. 5, the entitlement engine 140, brokerage engine 210, and/or other logic or service can operate to generate, manipulate and configure a set of staggered contribution periods 220 combing various various as short-term consumption periods 160 to permit diverse users and/or metered resources to be aggregated in the short-term user-aggregated excess capacity 202 and resource brokerage bundle 208 for potential consumption by the set of marketplace clouds 212 and/or other subscribers or users. In aspects, the set of staggered contribution periods 220 can be generated by the entitlement engine 140, brokerage engine 210, and/or other logic or service, and stored and/or encoded in a resource contribution arrange 218. In aspects, the resource contribution array 218 can include entries or values for the expected or scheduled excess capacity available from users in the set of users 190, recorded and/or organized in a set of staggered contribution periods 220. In aspects, the set of staggered contribution periods 220 can be selected and combined to generate a desired total mount of resources, such as software instances, processor, memory, and/or other resources to be combined over a continuous and/or defined period reflected in one or more dynamic resource contribution intervals 204. In aspects, the set of staggered contribution periods 220 can be selected to interleave or combine the time periods of various short-term consumption periods 160 available from two or more users, to generate a desired, preferred, and/or minimum amount of resources over defined or selected time periods. Thus for instance, and as illustratively shown, if a contribution of 50 operating system instances is desired, calculated, and/or requested for a resource brokerage bundle 208, and user 1 and user 2 can contribute 20 and 30 operating system instances, respectively, from 2:00 p.m. to 2:30 p.m., while user 3 can contribute 50 operating system instances from 2:30 to 3:00 p.m., the entitlement engine 140, brokerage engine 210, and/or other logic or service can configure a dynamic resource contribution interval of 1 hour from 2:00 p.m. to 3:00 p.m., while decomposing or arranging the set of staggered contribution periods 220 to include one half-hour interval from 2:00 p.m. to 2:30 p.m., and from 2:30 p.m. to 3:00 p.m. The entitlement engine 140, brokerage engine 210, and/or other logic or service can substitute or order the contributions by user 1, user 2, and user 3 within the respective intervals of the set of staggered contribution periods 220. For further example, if there is a desired, requested, and/or calculated contribution of 8 gigabytes of memory for a 1-hour interval from 3:00 to 4:00 p.m., and user 4 has 6 gigabytes available from 3:00 to 3:20 in twenty-minute increments, user 5 has 2 gigabytes available from 3:15 to 4:00 in 45-minute increments, user 6 has 6 gigabytes available from 3:30 to 4:00 in half-hour increments, and users 7 through 12 each have excess memory capacity of 1 gigabyte in one-minute increments from 2:00 to 5:00, the entitlement engine 140, brokerage engine 210, and/or other logic or service can schedule, arrange, or stagger the set of staggered contribution periods 220 to include user 4 and user 5 from 3:00 to 3:20, producing the desired 8 gigabyte total in that interval. For the period from 3:20 to 3:30, the entitlement engine 140, brokerage engine 210, and/or other logic or service can schedule, arrange, or stagger the set of staggered contribution periods 220 to include user 5 as well as users 7 through 12 to contribute 1 gigabyte of memory over that interval (ten one-minute increments), generating an availability of 8 gigabytes for that interval. For the period from 3:30 to 4:00, the entitlement engine 140, brokerage engine 210, and/or other logic or service can schedule, arrange, or stagger the set of staggered contribution periods 220 to include user 6 and two selected users from users 7 through 12 to arrive at the desired, requested, and/or calculated resource level of 8 gigabytes. It may be noted that in aspects, partial intervals can be extracted or accepted from users in order to align or synchronize the set of staggered contribution periods 220 and/or set of dynamic resource contribution intervals 204. In cases, the use of partial intervals can be accomplished by providing the contributing user a subscription fee or payment for the entire interval over which their resources will be dedicated to the set of marketplace clouds 212. In cases, the entitlement engine 140, brokerage engine 210, and/or other logic or service can approximate, for instance by rounding up, the necessary component intervals of the set of staggered contribution periods 220, when for instance the individual users are metered over odd or irregular intervals, and/or matching no other short-term subscription period 160 of other users.

In aspects, it may also be noted that the set of staggered contribution periods 220 can be generated to take into account the delivery of multiple resources in the resource brokerage bundle 208, in which case the set of staggered contribution periods 220 may be configured to mesh the time intervals of multiple users combined over multiple resources. In aspects, the set of dynamic resource contribution intervals 204 developed by staggering and configuring the set of staggered contribution periods 220 can be predetermined or fixed over relatively short periods, such as on a per-hour basis. In further cases, the set of dynamic resource contribution intervals 204 can itself be changed or adapted over time, for instance to ensure that a desired, requested, and/or calculated level of resources can be produced in the resource brokerage bundle 208. Thus for instance, to ensure a minimum contribution of 50 operating system instances in the resource brokerage bundle 208, the entitlement engine 140, brokerage engine 210, and/or other logic or service can generate a first resource contribution interval of 6:00 p.m. to 7:00 p.m., with a second interval of 7:00 p.m. to 8:30 p.m. to permit an aggregation of 50 operating system instances from diverse users having a shifting set of one or more short-term consumption periods 160. In aspects in further regards, the set of dynamic resource contribution intervals 204 can be specified or requested by the set of marketplace clouds 212, and/or can be set to a default value, such as one hour. Other configurations and relationships between the set of dynamic resource contribution intervals 204, the short-term user-aggregated excess capacity 202, one or more short-term subscription periods 160, and/or other time frames, periods, intervals, variables, and/or other parameters are possible.

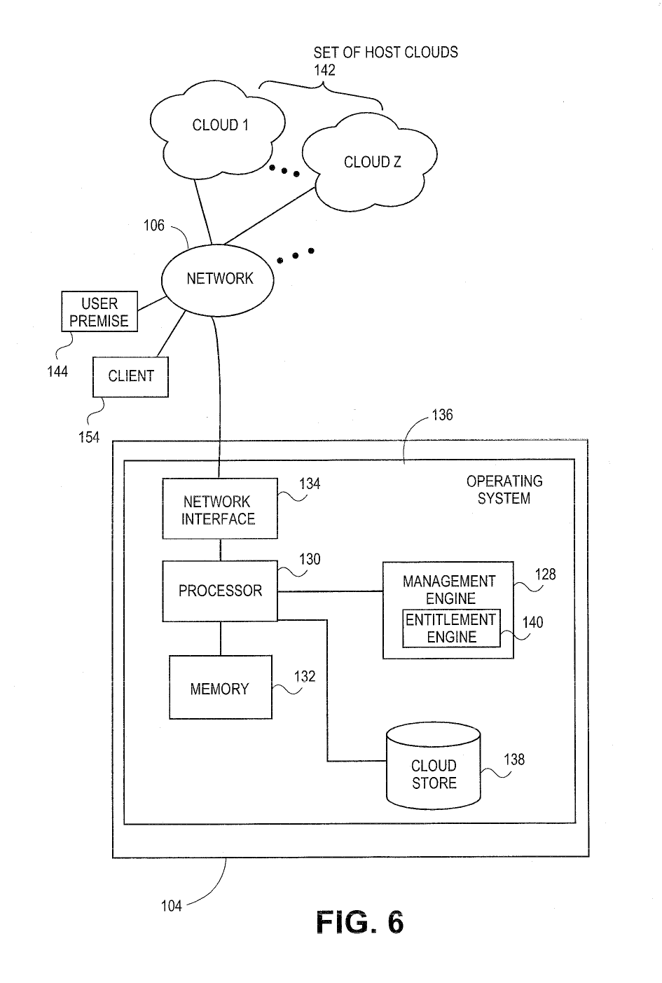

FIG. 6 illustrates an exemplary diagram of hardware and other resources that can be incorporated in a cloud management system 104 configured to communicate with the set of instantiated virtual machines 116, entitlement engine 140, user premise 144, client 154, set of host clouds 142, and/or other entities, services, or resources via one or more networks 106 and/or other connections, according to embodiments. In embodiments as shown, the cloud management system 104 can comprise a processor 130 communicating with memory 132, such as electronic random access memory, operating under control of or in conjunction with an operating system 136. The operating system 136 can be, for example, a distribution of the Linux™ operating system, the Unix™ operating system, or other open-source or proprietary operating system or platform. The processor 130 also communicates with a cloud store 138, such as a database stored on a local hard drive, and a management engine 128, to execute control logic and control the operation of virtual machines and other resources in one or more clouds 102, the set of host clouds 142, and/or other collections of clouds. The processor 130 further communicates with a network interface 134, such as an Ethernet or wireless data connection, which in turn communicates with the one or more networks 106, such as the Internet or other public or private networks. The processor 130 and/or the cloud management system 104 can likewise communicate with the entitlement engine 140, the set of subscription parameters 146, the set of usage history data 148, the user premise 144, the client 154, the set of host clouds 142, and/or other interfaces, applications, machines, sites, services, data, and/or logic. Other configurations of the cloud management system 104, associated network connections, and other hardware, software, and service resources are possible. it may be noted that in embodiments, the client 154, brokerage engine 210 if implemented separately, and/or other hardware machines, platforms, or engines can comprise the same or similar resources as cloud management system 104, or can be configured with different hardware and software resources.

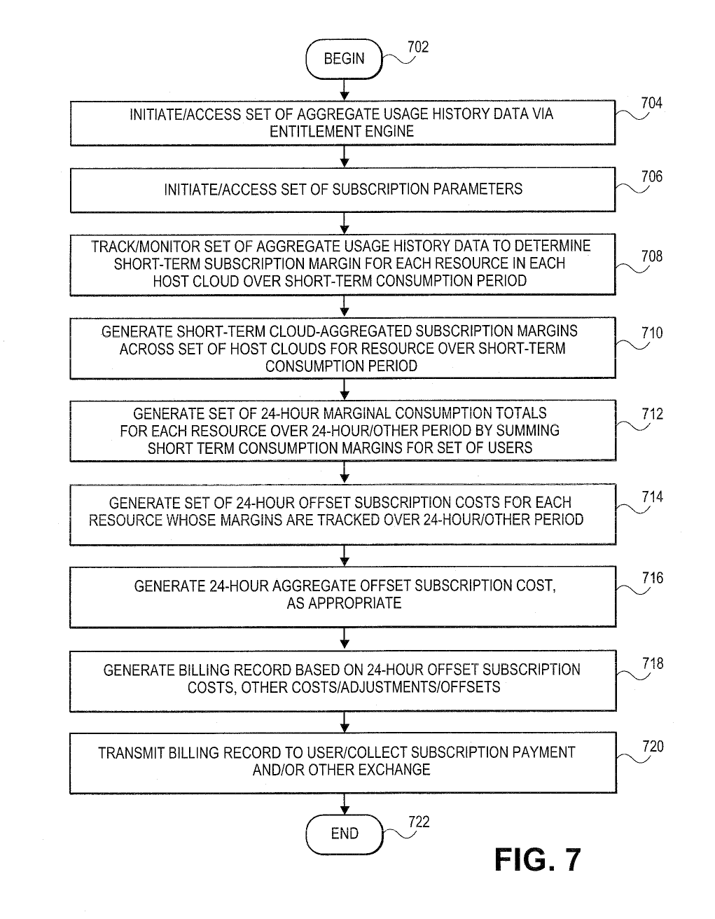

FIG. 7 illustrates a flowchart of overall processing to perform the tracking of resource consumption, management of subscription parameters, short-term billing capture and margin reconciliation and related activities, according to various embodiments of the present teachings. In 702, processing can begin. In 704, an administrator or other user can initiate and/or access the set of aggregate usage history data 148 for the set of users 190 and/or other user or users via the entitlement engine 140 and/or other logic. In 706, an administrator or other user can initiate and/or access the set of subscription parameters 146, indicating, for instance, resource consumption rates, limits, caps, and/or other subscription parameters or factors by which the set of users 190 can subscribe to resources of the set of host clouds 140. In 708, the entitlement engine 140 and/or other logic can track, register, and/or monitor the set of aggregate usage history data 148 to determine the short-term subscription margin 166 for each resource to which the set of users 190 subscribes, in each host cloud in set of host clouds 142 to which the user is registered. In aspects, the short-term subscription margin 166 can be tracked or monitored for each period in the one or more short-term consumption periods 160. In aspects, the one or more short-term subscription periods 160 can be or include one or more periods such as, for instance, one-hour periods as shown, and/or can also or instead include other periods such as periods or intervals of 1, 5, 10, 15, or 30 minutes, 8-hour periods, 12-hour periods, 24-hour periods, and/or other periods or intervals. in aspects, the one or more short-term consumption periods 160 can correspond to the short time periods tracked by the cloud management system, the entitlement engine 140, the set of host clouds 142, and/or other cloud logic or infrastructure. In aspects, the one or more short-term consumption periods 160 can comprise equally-spaced intervals, and/or can include intervals of different durations or lengths.

In 710, the entitlement engine 140 and/or other logic can sum the short-term subscription margin 166 across all users in the set of users 190 and/or all host clouds for each period of the one or more short-term consumption periods 160 to generate the short-term user-aggregated subscription margin 172 for that respective period. For instance, in exemplary records as shown in FIG. 4, the number of operating system (OS) instances instantiated and/or run by the set of users 190 in a given hour across the set of host clouds 142 can be totaled, so that instances of under-limit consumption offset instances of over-limit consumption, resulting in a net short-term cloud-aggregated subscription margin 178 for the one or more short-term consumption periods 160 across all users in set of users 190 for one or more all host clouds. In cases, the set of short-term user-aggregated margins 178 may reflect a net over-consumption (positive) value for that hour or other period (as illustratively shown), or can reflect an under-consumption (negative) value for that same period. A zero margin (at-limit) value can also be reflected.

In 712, the entitlement engine 140 and/or other logic can generate the set of marginal consumption totals 168 reflecting the total combined short-term subscription margin 166 for each resource being tracked over a 24-hour, or other interval or period. For example, and as shown for instance in FIG. 4, the under-limit (e.g. recorded as a negative value) and over-limit (e.g. recorded as a positive value) margins or increments of consumption under or over the short-term consumption limit 164 for each one or more short-term consumption periods 160 can be summed or combined to determine the set of short-term user-aggregated margins 178 for each respective resource over a 24-hour period, again for one or more host clouds. In aspects, other periods or intervals other than a 24-hour period can be used to sum the values reflected in the set of short-term user-aggregated margins 178. The values reflected in the set of short-term user-aggregated margins 178 can thereby reflect the netting out of the under-consumption and over-consumption values for a given resource in two or more dimensions, namely over multiple users and/or two or more host clouds, and over multiple instances of the one or more short-term consumption periods 160, averaging out consumption fluctuations by the set of users 190 in relation to the set of short-term consumption limits 164.

In 714, the entitlement engine 140 and/or other logic can generate the set of offset subscription costs 170 for each of the one or more short-term consumption periods 160 corresponding to the set of short-term user-aggregated margins 178 for each subscribed resource. For instance, if the record for a given one or more short-term consumption periods 160 reflects the over-consumption of 20 operating system instances, the assigned overage cost of that usage may be, for instance, $0.50 times 20 instances, or $10.00 for that hour or other period. In 716, the entitlement engine 140 and/or other logic can generate the aggregate offset subscription cost 174 for one 24-hour or other period, representing the combination of the set of offset subscription costs 170 over a multiple number of the one or more short-term consumption periods 160, such as the combination of 24 one-hour periods, or other intervals, periods, or multiples. In 718, the entitlement engine 140 and/or other logic can generate the billing record 150 based on the aggregate offset subscription cost 174 for each resource being tracked and/or metered for the set of users 190, and/or based on other costs, adjustments, offsets, and/or factors. In 720, the entitlement engine 140 and/or other logic, entities, or resources, such as the operator of the set of host clouds 142, can transmit the billing record 150 to an administrator for the set of users 190 and/or other user or other recipient. In 724, as understood by persons skilled in the art, processing can repeat, return to a prior processing point, jump to a further processing point, or end.

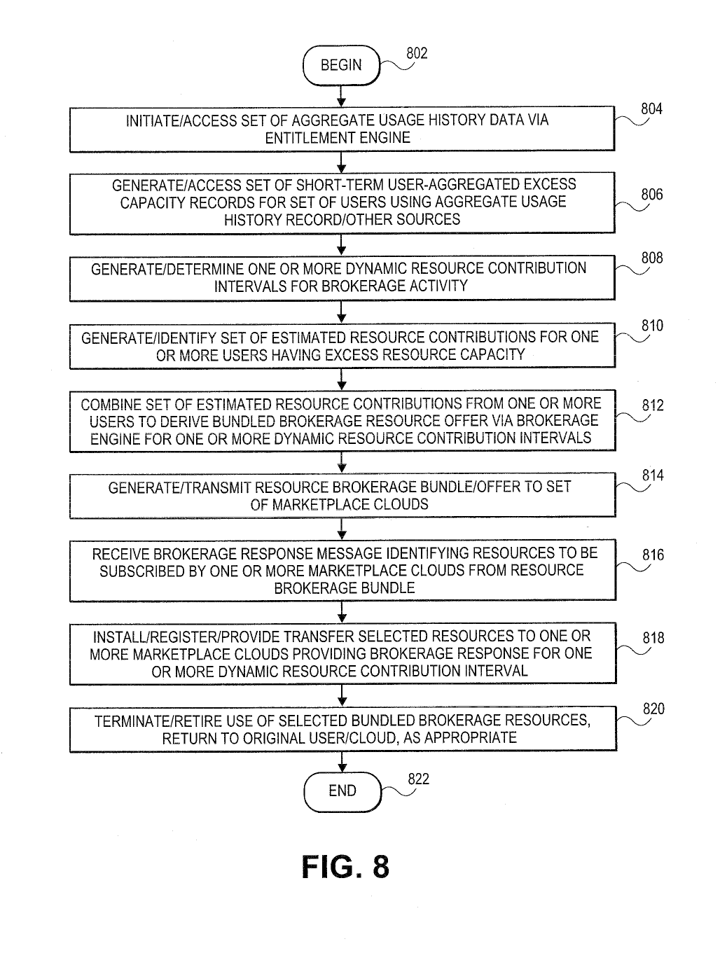

FIG. 8 illustrates various processing that can be used in generating marketplace brokerage exchange of excess subscribed resources using dynamic subscription periods, according to various aspects of the present teachings. In aspects as shown, in 802, processing can begin. In 804, the set of aggregate usage history data 148 containing consumption data for the set of users 190 can be initiated and/or accessed using the entitlement engine 140 and/or other logic or service, for instance by a cloud provider, systems administrator for the set of users 190, and/or other user(s). In 806, the entitlement engine 140 and/or other logic or service can generate, read, and/or otherwise access the set of short-term user-aggregated excess capacity records for the set of users 190, for instance by accessing or using the aggregate usage history record 180 and/or other source. In 808, the brokerage engine 210, entitlement engine 140, and/or other logic or service can generate and/or determine one or more dynamic resource contribution intervals 204 for purposes of conducting cloud brokerage activities. For instance, the set of dynamic resource contribution intervals 204 can be set to the minimum common denominator of intervals used by the set of users 190. For further instance, the set of dynamic resource contribution intervals 204 can be set to another value, such as one hour, two hours, 12 hours, one day, and/or other fixed interval or period, for instance based on data from the set of marketplace clouds 212 indicating a needed period for additional brokered resources.

In 810, the brokerage engine 210, entitlement engine 140, and/or other logic or service can generate, identify, and/or access the set of estimated resource contributions 206 to be made from the subscribed resources of one or more users in the set of users 190 having anticipated or demonstrated excess resource capacity. For instance, a user for whom the short-term consumption margin 166 has trended toward or reflected an under-consumption of 20 operating system instances over one or more short-term consumption periods 160, such as one hour, over the last two days can be estimated or calculated to be able to contribute 10 operating system instances (50% of the under-consumption margin) over a set of dynamic resource contribution intervals 204 of the next 12 hours, and/or other interval or period. In aspects, one or more users in the set of users 190 can contribute two or more resources over the set of dynamic resource contribution intervals 204 and/or other period. In 812, the brokerage engine 210, entitlement engine 140, and/or other logic or service can combine the set of estimated resource contributions 206 for one or more users in the set of users 190 determined to have excess resources or capacity to provide for brokerage purposes, to derive a resource brokerage bundle 208. In aspects, the resource brokerage bundle 208 can be generated for one or more of the set of dynamic resource contribution intervals 204. In aspects, different combinations of resources can be combined and presented in different or updated resource brokerage bundles 208 generated for different time periods or intervals.

In 814, the brokerage engine 210, entitlement engine 140, and/or other logic or service can encode and/or transmit the resource brokerage bundle 208 to the set of marketplace clouds 212, for instance via one or more networks 106 and/or other channels or connections. In 816, the set of marketplace clouds 212 can receive, distribute, and/or analyze the resource brokerage bundle 208 to determine a brokerage response message 214 reflecting the selection, identification, and/or acceptance of one or more resources encoded in the resource brokerage bundle 208 by one or more clouds in the set of marketplace clouds 212. In 818, the brokerage engine 210, entitlement engine 140, and/or other logic or service can receive the brokerage response message 214 from the set of marketplace clouds 212 identifying one or more resources to be subscribed to by one or more clouds in the set of marketplace clouds 212 for or over one or more dynamic resource contribution interval 204, such as one hour, two hours, 12 hours, one day, and/or other period or interval. In 820, the entitlement engine 140, cloud management system(s) 104, brokerage engine 210, and/or other logic or service can install, register, and/or otherwise provide the selected resources to the one or more marketplace clouds 212 which have accepted those resources identified in the resource brokerage bundle 208, for instance by registering those resource(s) to a cloud management 104 corresponding to the recipient marketplace cloud in the set of marketplace clouds 212. In 824, the entitlement engine 140, cloud management system(s) 104, brokerage engine 210, and/or other logic or service can terminate and/or otherwise retire the use of the resources selected from the resource brokerage bundle 208, and return the use of those resources to the contributing user and/or other entity, as appropriate. In 824, the entitlement engine 140, cloud management system(s) 104, brokerage engine 210, and/or other logic or service can generate a subscription report and/or other message reflecting metering, billing, and/or other administration of the temporary use of the brokered resources in the resource brokerage bundle 208, such as for instance to generate a payment or credit to the user or users contributing one or more resources in or from the resource brokerage bundle 208. In 826, as understood by persons skilled in the art, processing can repeat, return to a prior processing point, jump to a further processing point, or end.

The foregoing description is illustrative, and variations in configuration and implementation may occur to persons skilled in the art. For example, while embodiments have been described in which the cloud management system 104 for a particular cloud resides in a single server or platform, in embodiments the cloud management system 104 and associated logic can be distributed among multiple servers, services, or systems. Similarly, while embodiments have been described in which one group of servers within a set of resource servers 108 can provide one component to build a requested set of virtual machines, in embodiments, one group of resource servers can deliver multiple components to populate the requested set of instantiated virtual machines 116, and/or other machines, entities, services, or resources. For further example, while embodiments have been described in which a user connects to or accesses the entitlement engine 140 via one client 154, in embodiments, multiple clients, portals, services, and/or other access points to the entitlement engine 140 can be used. Likewise, while embodiments have been described in which one entitlement engine 140 operates to manage the resource consumption, billing, and/or other activities of one or more users in a set of host clouds 142, in embodiments, multiple deployment engines and/or other logic or services can perform the same or similar logic to manage deployment options. Other resources described as singular or integrated can in embodiments be plural or distributed, and resources described as multiple or distributed can in embodiments be combined. The scope of the invention is accordingly intended to be limited only by the following claims.

What is claimed is:

1. A method of brokering cloud resources, comprising:
accessing a set of aggregate usage history data for a set of users each operating a set of machines consuming a set of resources in at least one host cloud;
generating a set of short-term consumption margins for each user in the set of users based on the consumption of the set of resources over one or more short-term consumption periods in the at least one host cloud;
identifying a short-term user-aggregated excess capacity value based on the set of short-term consumption margins for the set of resources of each user representing excess capacity;
generating a resource brokerage bundle based on the short-term user-aggregated excess capacity value of the set of resources of the users;
transmitting the resource brokerage bundle to a set of marketplace clouds; and
receiving a brokerage response message from the set of marketplace clouds indicating an acceptance or rejection of the resource brokerage bundle to support one or more of the set of marketplace clouds.

2. The method of claim 1, wherein the one or more short-term consumption periods for at least one of the set of users is dynamically updated based on the short-term consumption margins for the at least one user.

3. The method of claim 1, wherein at least some of the one or more short-term consumption periods for each user are the same.

4. The method of claim 1, wherein at least some of the one or more short-term consumption periods for each user are different.

5. The method of claim 4, further comprising combining the different consumption periods to produce one or more dynamic resource contribution intervals.

6. The method of claim 5, further comprising restoring the resources in the selected resource brokerage bundle to the respective contributing users upon completion of the one or more dynamic resource contribution intervals.

7. The method of claim 5, wherein the one or more dynamic resource contribution intervals comprises different intervals of respective users which are combined to produce the one or more dynamic resource contribution intervals.

8. The method of claim 1, wherein the resource brokerage bundle comprises an offer to provide a percentage of the excess capacity value of the resources contributed by the respective users.

9. The method of claim 5, wherein the one or more dynamic resource contribution intervals comprise a set of intervals of the same length starting at different times.

10. The method of claim 5, wherein the one or more dynamic resource contribution intervals comprise a set of intervals of different lengths starting at different times.

11. The method of claim 5, wherein the resource brokerage bundle comprises a combined excess capacity for a set of resources aggregated to reach a minimum resource contribution threshold for the one or more dynamic resource contribution intervals.

12. The method of claim 1, wherein the set of resources comprises at least one of operating system instances, software application instances, virtual machine instances, virtual appliance instances, processor resources, memory resources, storage resources, communications resources, or user-subscribed services.

13. The method of claim 1, further comprising metering the set of contributed resources to generate a compensation value for the users contributing resources to the set of marketplace clouds.

14. The method of claim 1, further comprising establishing a set of failover resources for at least one user in the set of users in the event that the set of short-term consumption margins increases to eliminate the excess capacity of the resource contributed by the at least one user.

15. A system for brokering cloud resources, comprising:
an interface to a data store, the data store storing a set of aggregate usage history data for a set of users operating a set of machines consuming a set of resources in a set of host clouds; and
a processor, communicating with the data store via the interface, the processor being configured to—
access the set of aggregate usage history data,
generate a set of short-term consumption margins for each user in the set of users based on the consumption of the set of resources over one or more short-term consumption periods in the at least one host cloud,
identify a short-term user-aggregated excess capacity value based on the set of short-term consumption margins for the set of resources of each user representing excess capacity,
generate a resource brokerage bundle based on the short-term user-aggregated excess capacity value of the set of resources of the users,
transmit the resource brokerage bundle to a set of marketplace clouds, and
receive a brokerage response message from the set of marketplace clouds indicating an acceptance or rejection of the resource brokerage bundle to support one or more of the set of marketplace clouds.

16. The system of claim 15, wherein the one or more short-term consumption periods for at least one of the set of users is dynamically updated based on the short-term consumption margins for the at least one user.

17. The system of claim 15, wherein at least some of the one or more short-term consumption periods for each user are the same.

18. The system of claim 15, wherein at least some of the one or more short-term consumption periods for each user are different,

19. The system of claim 18, wherein the processor is further configured to combine the different consumption periods to produce one or more dynamic resource contribution intervals.

20. The system of claim 19, wherein the process is further configured to restore the resources in the selected resource brokerage bundle to the respective contributing users upon completion of the one or more dynamic resource contribution intervals.

21. The system of claim 19, wherein the one or more dynamic resource contribution intervals comprises different intervals of respective users which are combined to produce the one or more dynamic resource contribution intervals.

22. The system of claim 15, wherein the resource brokerage bundle comprises an offer to provide a percentage of the excess capacity value of the resources contributed by the respective users.
